(19) United States
(12) Patent Application Publication
(10) Pub. No.: US 2003/0123411 A1
(43) Pub. Date: Jul. 3, 2003

(54) Vocoding apparatus and method

(75) Inventor: Dong-Sung Kim, Kyungki-Do (KR)

Correspondence Address: FLESHNER & KIM, LLP, P.O. Box 221200, Chantilly, VA, 20153-1200, US

(73) Assignee: LG Electronics Inc.

(21) Appl. No.: 10/330,352

(22) Filed: Dec. 30, 2002

(30) Foreign Application Priority Data
Dec. 31, 2001 (KR) 89272/2001

(51) Int. Cl. H04B 7/216

(52) U.S. Cl. 370/335; 370/342

(57) ABSTRACT

A vocoding apparatus, and method that reduces a real-time response burden acting on a digital signal processor to improve a performance of the DSP, minimize data loss due to slip occurrence, etc. and minimize data retransmission due to data loss. The vocoding apparatus includes a TDM switch for processing a voice signal and a data signal received from a mobile switching center according to a time division multiplexing method; a digital signal processor for receiving the voice signal and the data signal outputted from the switch and performing a certain digital signal processing; a signal delayer for adjusting an amount of the data signal transmitted from the switch to the Digital Signal Processor according to a load quantity of the Digital Signal Processor; and a CPU for controlling the Digital Signal Processor.

### BACKGROUND OF THE INVENTION

1. Field of the Invention

The present invention relates to a mobile communication base station controller, and in particular to a vocoding apparatus based on low speed transmission.

2. Background of the Related Art

With a transition from an analog transmission basis to a digital transmission basis in mobile communication techniques, the International standard organization developed IS-95A, IS-95B, and IS-95C as transmission standards for a radio region (example: between a terminal and a base station) of a synchronous mobile communication network. Analog transmission standards for the radio region is the 1st generation technique, IS-95A is the 2nd generation technique, IS-95B is the 2.5 generation technique, and IS-95C is the 3rd generation technique.

IS-95A is a transmission standard for voice call and low speed (9.6 Kbps) radio communication. IS-95B is the same standard as IS-95A, however, it can provide a maximum of 8 traffic channels for one user and has a transmission speed (64 Kbps) four˜eight times faster than that of IS-95A. IS-95C is the International radio transmission standard providing a high speed transmission speed (128 Kbps) while maintaining compatibility with IS-95A and IS-95B.

FIG. 1 is a block diagram illustrating a general synchronous mobile communication network.

As depicted in FIG. 1, IS-95A and IS-95B transmit voice call and data through a circuit transmission channel. In a voice call service, a mobile terminal 10 compresses a voice signal of a subscriber by using a compression algorithm and converts the compressed voice signal into a digital signal. The converted signal is transmitted to a BTS (base station) 30 through a certain procedure for radio transmission. The base station 30 transmits the received signal to a BSC (base station controller) 40.

The signal of the BTS 30 is converted into a pulse code modulation (PCM) data in a vocoder block 50 of the BSC 40 and then transmitted to an exchanger of a receiving party through a mobile switching center (MSC) 60.

In the data service, a data signal of the mobile terminal 10 is transmitted to the exchanger of the receiving party by passing the vocoder block 50 of the BSC 40 and the MSC 60 through the existing 2nd generation network circuit transmission channel.

Hereinafter, the conventional vocoding apparatus will be described with reference to FIG. 2.

FIG. 2 is a block diagram illustrating the conventional vocoding apparatus.

As depicted in FIG. 2, the conventional vocoding apparatus 50 consists of a low speed service block 150 for providing an IS-95A/B voice call service, an IS-95A data service; and a high speed block 160 for providing an IS-95B data service.

The low speed service block 150 includes a central processing unit (CPU) 110 for controlling an output of frame transmission between the BTS 30 and the BSC 40 and controlling a soft-handoff; and a digital signal processor (DSP) 120 for converting voice data received from the BIS 30 into PCM data.

In addition, the high speed service block 160 includes a CPU 115 for controlling an output of frame transmission between the BTS 30 and the BSC 40 and controlling a soft-handoff; and an inter system link layer protocol (ISLP) private CPU 130 for performing a high speed data transmission service (IS-95B data service). The ISLP is a protocol for maintaining reliability of data transmission between systems such as the MSC 60 or BSC 40. In addition, it is a link layer related protocol having functions such as a bit stuffing and a flow control function, etc. and is similar to a high-level data link control (HDLC) processing.

In the early stage of digital mobile communication, the vocoding apparatus 50 mainly performed a voice call service processing of a subscriber. However, in response to a great demand for data service, the DSP 120 of the vocoding apparatus 50 performs not only the voice call service but also a low-speed data transmission service (IS-95A data service). Those performances of the DSP 120 are inefficient in the functional aspect. However, it has an advantage in that a data service can be performed through the existing voice route.

With the advent of the IS-95B technique, when a high speed data transmission (64 Kbps) service required in the IS-95B technique is performed in the low speed data service block 150, several functional problems occur in the vocoding apparatus. Those problems will be described.

First, because ISLP protocol processing for high speed data transmission has to be performed in the DSP 120, the DSP 120 is requited to have a performance reaching a certain level in order to perform the protocol processing. Specifically, in TDM (time division multiplex) transmissions requiring real-time response (respondency), the DSP 120 must avoid frequent interrupt occurrences. Those frequent interrupts may burden other internal operations (protocol processing, etc.) of the DSP 120. Accordingly, a DSP 120 having a very high performance is required.

Second, in the conventional DSP 120, it is difficult to restore transmission error due to jitter. It has been known since the advent of IS-95B technique, because the conventional DSP 120 does not have a buffering function for data received from the MSC 60, when a slip of a synchronous signal occurs, data loss cannot be avoid. In a voice call case, because of characteristics of voice data, data loss does not affect next data transmitted. However, in high speed data, although data loss occurs by bit units, whole data has to be retransmitted. Since the procedure is performed in the DSP 120, a DSP 120 having a higher performance is required.

In order to solve the above-mentioned problems, the high speed service block 160 for performing IS-95B data service is added to the vocoding apparatus 50. In order to solve the second problem, a HDLC controller and a buffer (or S/W queue) are additionally built in the ISLP private CPU 130 of the high speed service block 160. The low speed service block 150 of the conventional vocoding apparatus 50 processes the IS-95B voice call service.

However, as described above, there are also following problems in duplexing the vocoding apparatus 50 as the IS-95A service block 150 and the IS-95B service block 160.

First, there is resources management and efficiency problem in the system. Under limited MSC matching resources, by forming the duplex route with the low speed service block 150 and the high speed service block 160 in the system, it causes difficulties in call processing resources management and allocation, and expansion of the system is limited. All voice calls have to pass the low speed service block 150, however, in the high speed data service performance, because selector resources (CPU) of the low speed service block 150 are not used, it is inefficient.

Second, there is a concurrent service providing problem.

The concurrent service means an IS-95B subscriber requests a voice call service and a high speed data call service simultaneously or initiates a voice call while maintaining a high speed data call. The concurrent service is one of mobile communication subscriber service options, a standard for this option is already set up. As described above, the conventional vocoding apparatus 50, which is divided into the service block 150 for IS-95A and the service block 160 for IS-95B, cannot support the concurrent service. That is because the low speed service block 150 and the high speed service block 160 do not hold the selector resources (CPU) jointly, only separately.

The above references are incorporated by reference herein where appropriate for appropriate teachings of additional or alternative details, features and/or technical background.

### SUMMARY OF THE INVENTION

One embodiment of the present invention provides a vocoding apparatus and method capable of performing a high speed transmission service by using a low speed transmission basis DSP.

According to one embodiment, a vocoding apparatus includes a TDM switch for processing a voice signal and a data signal received from a MSC (mobile switching center) according to a time division multiplexing method; a DSP (digital signal processor) for receiving the voice signal and the data signal outputted from the switch and performing a certain digital signal processing; a signal delayer for adjusting an amount of the data signal transmitted from the switch to the DSP according to a load quantity of the DSP; and a CPU for controlling the DSP.

The signal delayer includes a serial-parallel converter for converting the output signal of the switch into a parallel signal; a buffer for storing the parallel signal; a parallel-serial converter for converting the signal stored in the buffer into a serial signal and transmitting it to the DSP; and a buffer controller for controlling signal input/output of the buffer.

A vocoding method in accordance with one embodiment of the present invention includes transmitting a signal directly to a DSP (digital signal processor) when the signal from a MSC (mobile switching center) to a TDM switch is a voice signal and transmitting a signal to the DSP through a signal delayer when the signal is a data signal; adjusting a transmission amount of the signal transmitted from the signal delayer to the DSP by checking a load quantity of the DSP; and performing a certain digital signal processing on the transmitted voice signal and data signal.

### BRIEF DESCRIPTION OF THE DRAWINGS

The invention will be described in detail with reference to the following drawings in which like reference numerals refer to like elements wherein:

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a general synchronous mobile communication network;

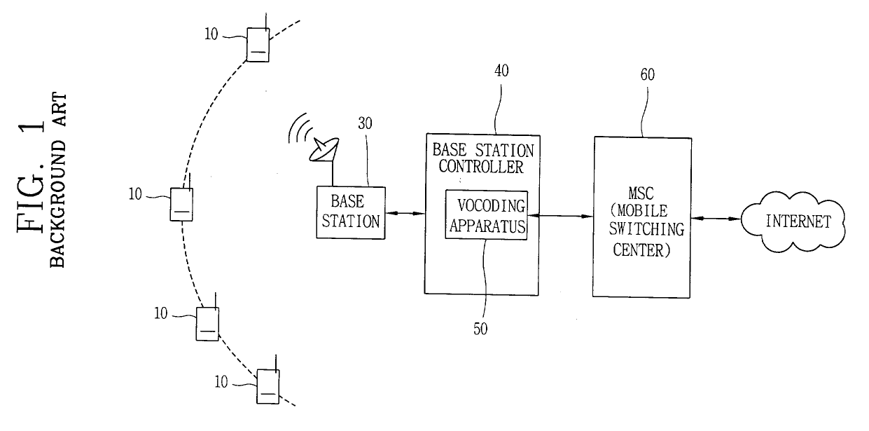

FIG. 2 is a block diagram illustrating functions of the conventional vocoding apparatus;

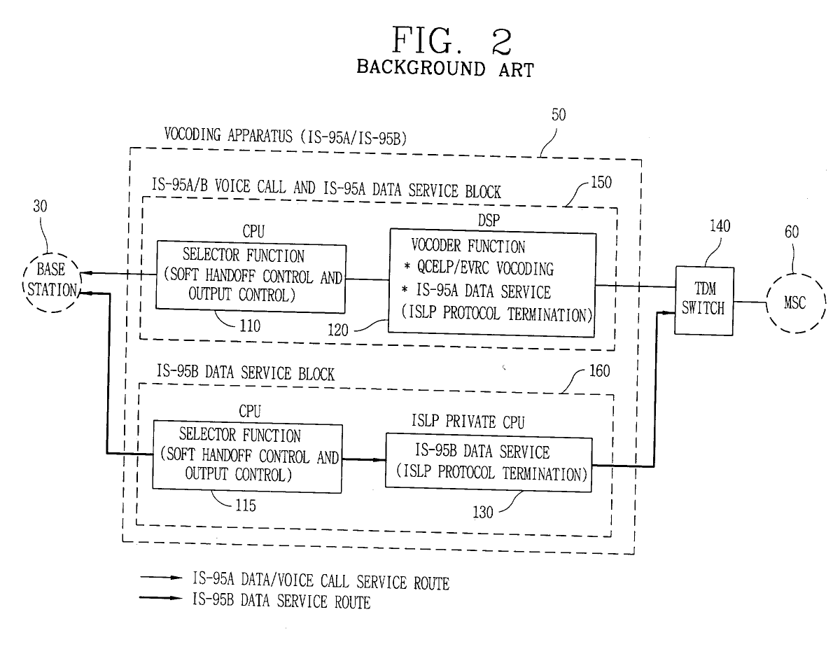

FIG. 3 is a block diagram illustrating a vocoding apparatus in accordance with one embodiment of the present invention;

FIG. 4 is a detailed block diagram illustrating a vocoding apparatus in accordance with the one embodiment of the present invention;

FIG. 5 is a flow chart illustrating a vocoding method in accordance with one embodiment of the present invention; and

FIG. 6 is an exemplary view illustrating an operation of a TDM frame delayer.

### DETAILED DESCRIPTION OF PREFERRED EMBODIMENTS

Hereinafter, the embodiments of the present invention will be described with reference to accompanying drawings.

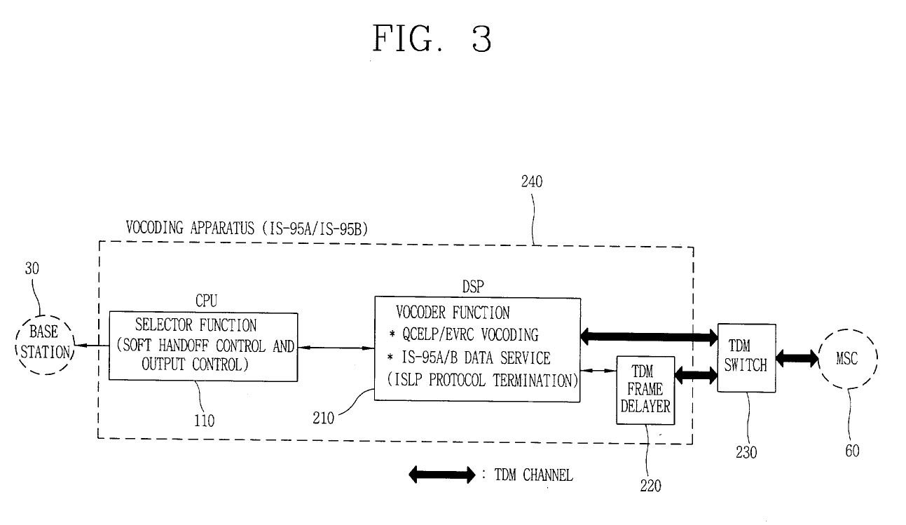

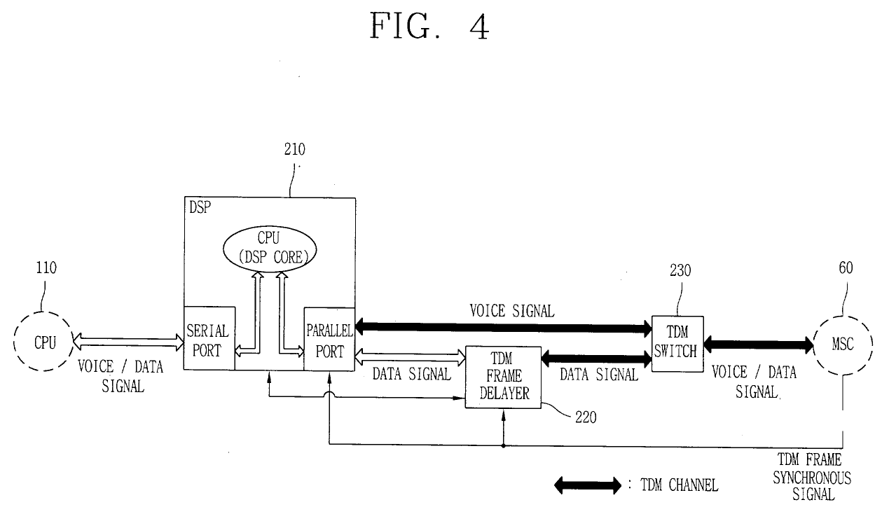

FIG. 3 is a block diagram illustrating a vocoding apparatus in accordance with one embodiment of the present invention, and FIG. 4 is a detailed block diagram illustrating a vocoding apparatus in accordance with one embodiment of the present invention.

As depicted in FIGS. 3 and 4, the vocoding apparatus includes a TDM switch 230 for processing a voice signal and a data signal received from a MSC (mobile switching center) 60 according to a time division multiplexing method; a DSP 210 for receiving the voice signal and the data signal outputted from the switch 230 and performing a certain digital signal processing; a signal delayer (or a TDM frame delayer) 220 for adjusting an amount of the data signal of the switch 230 transmitted to the DSP 210 according to a load quantity of the DSP 210; and a CPU 110 for controlling the DSP 210.

The signal delayer 220 includes a serial-parallel converter 330 for converting the output signal of the switch 230 into a parallel signal; a buffer 320 for storing the parallel signal; a parallel-serial converter 310 for converting the signal stored in the buffer 320, converting it into a serial signal and transmitting it to the DSP 210; and a buffer controller 340 for controlling signal input/output of the buffer 320.

The serial-parallel converter 330 and the parallel-serial converter 310 are converters having both a function for converting serial data into parallel data and a function for converting parallel data into serial data.

In the construction of the conventional vocoding apparatus 50, the DSP 210 is directly connected to the TDM switch 230. Specifically, in the conventional art, there is no additional hardwire for buffering between the DSP 210 and the TDM switch 230, and the DSP 210 is subordinated to the TDM switch 230 in operation. However, in the vocoding apparatus 240 in accordance with one embodiment of the present invention, there is the TDM frame delayer 220 between the DSP 210 and the TDM switch 230. Thus, a high speed data service can be performed by using the existing voice call service processing DSP without using an additional high data transmission (or HDLC control) CPU.

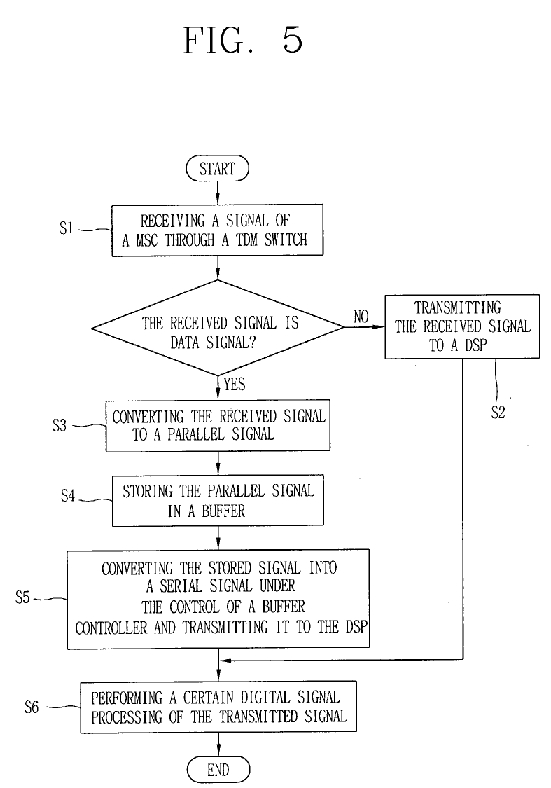

FIG. 5 is a flow chart illustrating a vocoding method in accordance with one embodiment of the present invention.

As depicted in FIG. 5, the vocoding method includes transmitting a signal directly to the DSP 210 when the signal from the MSC 60 to the TDM switch 230 is a voice signal and transmitting a signal to the DSP 210 through the signal delayer 220 when the signal is a data signal as shown at S2; adjusting a transmission amount of the signal transmitted from the signal delayer 220 to the DSP 210 by checking a load quantity of the DSP 210; and performing a certain digital signal processing on the transmitted voice signal (or data signal).

The transmission amount adjusting may include converting the signal transmitted to the DSP 210 into a parallel signal as shown at S3; storing the parallel signal in a buffer as shown at S4; converting the stored signal into a serial signal and transmitting the serial signal to the DSP 210 under the control of the buffer controller 340 as shown at S5.

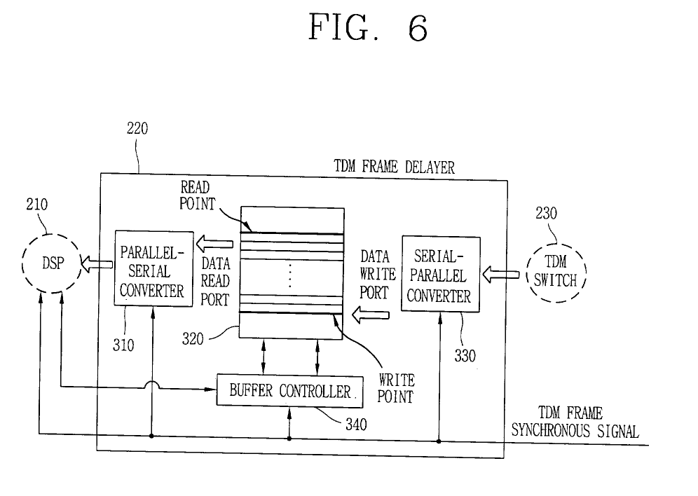

FIG. 6 is an exemplary view illustrating an operation of a TDM frame delayer.

With reference to FIGS. 4˜6, the operation of the vocoding apparatus in accordance with one embodiment of the present invention will be described in detail.

First, IS-95A/B data transmission service is described. In time division multiplexed data (high speed ISLP data or low speed ISLP data) transmitted from the MSC 60, data of a certain time slot is extracted by the TDM switch 230 and is transmitted to the serial-parallel converter 330 of the TDM frame delayer 220. The serial-parallel converter 330 converts the transmitted data into parallel data and writes the data in the buffer 320 through a write port of the buffer 320. The buffer controller 340 performs the ‘write operation’ according to a clock signal received from a mobile communication exchanger 60. In addition, the clock signal is provided to the parallel-serial converter 310 and the serial-parallel converter 330 and controls the mutual conversion operation.

In the meantime, the parallel data stored in the buffer 320 is converted into serial data by the parallel-serial converter 310 and is transmitted to a serial port of the DSP 210. The buffer controller 340 adjusts an amount of output data of the buffer 320 so it is possible to process the high speed IS-95B subscriber data transmitted from the TDM switch 230 in the low speed IS-95A DSP 210.

More specifically, the buffer controller 340 checks a load quantity of the DSP 210, when a load quantity of the DSP 210 increases, it increases a data storage capacity of the buffer 320. When a load quantity of the DSP 210 decreases, it decreases a data storage capacity of the buffer 320. Accordingly, a data transmission amount of the TDM frame delayer 220 transmitted to the DSP 210 is adjusted. An amount of data stored in the buffer 320 is a difference (interval) value between a read pointer value and a write pointer value.

By including the TDM frame delayer 220, the burden of real-time response is greatly reduced in comparison with a conventional DSP, and it is possible to remove a bit error caused by jitter noise in the connecting structure between the conventional vocoding apparatus 50 and the TDM switch 140.

When the vocoding apparatus according to one embodiment performs IS-95A/B voice call service, the DSP 210 and the TDM switch 230 transmit/receive a voice signal directly without passing through the TDM frame delayer 220.

By reducing the real-time response burden of the DSP 210 the performance of the DSP 210 is improved, data loss due to slip occurrence, etc. is minimized and data retransmission due to data loss is also minimized.

In addition, because the vocoding apparatus can perform a high speed data service with the voice call service processing DSP, a concurrent service can be provided to an IS-95B subscriber, and accordingly it is possible to simply manage resources efficiently.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An apparatus, comprising:
a switch that receives a voice signal and a data signal from a mobile communication system;
a buffer coupled to the switch, the buffer receives the data signal from the switch; and
a processor coupled to the buffer, the processor receives the voice signal from the switch and the data signal from the buffer.

2. The apparatus of claim 1, wherein the buffer adjusts an amount of the data signal received by the processor.

3. The apparatus of claim 2, wherein the buffer adjusts the amount of the data signal received by the processor based on a load of the processor.

4. The apparatus of claim 1, wherein the buffer further comprises:
a first converter that converts the data signal received from the switch to a parallel data signal;
a storage that stores the parallel data signal; and
a second converter that converts the stored parallel data signal to a series data signal.

5. The apparatus of claim 4, wherein the buffer further comprises a controller that controls an amount of the series data signal received by the processor.

6. The apparatus of claim 5, wherein the controller controls the amount of the series data signal received by the processor by adjusting a storage capacity of the storage.

7. The apparatus of claim 6, wherein the storage capacity of the storage is an interval between a read pointer and a write pointer.

8. The apparatus of claim 7, wherein the buffer synchronizes a data converting operation and a data storage operation.

9. The apparatus of claim 8, wherein the data converting operation and the data storage operation are synchronized based on a synchronizing signal from the switch.

10. An apparatus for signal processing is a mobile communication system; comprising;
a time division multiplex switch that processes a voice signal and a data signal from a mobile switch center;
a processor that receives the voice signal and the data signal from the time division multiplex switch, and
a delayer that adjusts an amount of the data signal transmitted from the switch.

11. The apparatus of claim 10, wherein the delayer adjusts the amount of the data signal transmitted based on a load of the processor.

12. The apparatus of claim 10, wherein the delayer adjusts the amount of the voice signal transmitted from the switch.

13. A method of signal processing in a mobile communication system, comprising:
receiving a signal having a voice signal and a data signal;
transmitting the received signal to a processor; and adjusting a transmission amount of the transmitted signal based on a load of the processor

14. The method of claim 13, further comprising:
transmitting the signal from the switch to a buffer; and transmitting the received signal from the buffer to the processor.

15. The method of claim 14, wherein the data signal is transmitted from the switch to the buffer and the voice signal is transmitted from the switch to the processor.

16. The method of claim 13, further comprising:
transmitting the voice signal from the switch to the processor;
transmitting the data signal from the switch to a buffer; and
transmitting the data signal from the buffer to the processor:

17. The method of claim 16, further comprising adjusting the transmitted amount of the data signal from the buffer to the processor.

18. The method of claim 13, further comprising:
converting the transmitted signal into a parallel signal;
storing the parallel signal;
converting the stored parallel signal into a serial signal; and
transmitting the serial signal to the processor.

19. The method of claim 18, further comprising storing the parallel signal in a buffer.

20. The method of claim 19, further comprising adjusting the transmission amount of the transmitted serial signal by adjusting a storage capacity of the buffer.

21. The method of claim 20, wherein the storage capacity of the buffer is adjusted by adjusting a read pointer and a write pointer of the buffer.

22. The method of claim 14, further comprising synchronizing an input and an output of the buffer based on a synchronizing signal from the switch.
